(19) United States
(12) Patent Application Publication
(10) Pub. No.: US 2011/0260598 A1
(43) Pub. Date: Oct. 27, 2011

(54) LED LAMP TUBE

(76) Inventor: Hang-Wan Liu, Taipei County (TW)

(21) Appl. No.: 12/766,547

(22) Filed: Apr. 23, 2010

(51) Int. Cl. H01J 61/52

(52) U.S. Cl. 313/46

(57) ABSTRACT

An LED lamp tube comprises a heat-dissipating ring, presented as an annulus having a ring base, an inner ring plate, and an outer ring plate; a transparent ring, an inner edge thereof being bonded to the inner ring plate of the heat-dissipating ring, and an outer edge thereof being bonded to the outer ring plate of the heat-dissipating ring; and an LED emitter including at least two circuit substrates connected to each other to form a ring, LED dies bonded to each of the circuit substrates, transformers, and a connection terminal, the LED emitter being further bonded between the heat-dissipating ring and the transparent ring. Thereby, the objectives of shape diversity, material saving for circuit substrates, heat-dissipation enhancement, and easy replacement of lamp tubes may be achieved by the LED lamp tube of the present invention.

### FIELD OF THE INVENTION

The present invention is related to an LED lamp tube, particularly to a structural design of an LED lamp tube composed of LEDs.

### BACKGROUND OF THE INVENTION

For a traditional lighting device, an incandescent bulb is usually used as an emitter. The conventional incandescent bulb is gradually substituted, owing to its drawbacks including high electric power consumption, short service life, and so on, opposite to the mainstream trend of energy saving and carbon reduction, by an innovative light-emitting diode (LED) lamp device with high brightness. The structure of an LED lamp tube used in a conventional LED lamp device includes a plurality of packaged LED dies welded on a strip-shaped circuit substrate, the strip-shaped circuit substrate being then welded or riveted in a lamp tube, so as to be provided and installed in the LED lamp device. In the conventional LED lamp tube, however, a circuit substrate is presented as a strip shape limitedly and the LED dies are then bonded to this strip-shaped circuit substrate for avoiding the waste of material for circuit substrates. For instance, when a raw board for circuit substrates is cut into circular ring-shaped or other ring-shaped circuit substrates, the material in the center and periphery may be wasted. Thus, the variation in the modeling of LED lamp tubes and lamp devices may be limited. For example, a circular ring-shaped or other shaped lamp device is impossibly formed. Moreover, a rational design for heat-dissipating structure is often absent in the conventional LED lamp tube, in such a way that either complex heat-dissipating fins resulting in costly LED lamp tubes, or poor heat-dissipation resulting in shortened service life may occur. It is evident that the problems of difficulty in taking account of both material saving and modeling diversity, as well as difficulty in designing the heat-dissipating structure rationally occur in the conventional structure of LED lamp tube. Nevertheless, these problems may be not overcome by the technology of traditional lamp devices, either. A further innovative improvement is therefore desirably required.

Thus, how to devise an LED lamp tube, capable of achieving the objectives of shape diversity, material saving for circuit substrates, heat-dissipation enhancement, easy replacement of lamp tubes, and so on, will be what the invention intends to disclose actively.

### SUMMARY OF THE INVENTION

In view of the drawbacks in the above conventional art, the applicant has exhausted himself to do research with great effort, in order to overcome these imperfections by means of experience accumulated by working in this industry for many years. An LED lamp tube is then developed so as to desirably achieving the objectives of shape diversity of LED lamp tubes, material saving for circuit substrates, heat-dissipation enhancement, and easy replacement of lamp tubes.

It is a primary object of the present invention to provide an LED lamp tube, capable of achieving the objectives of shape diversity of LED lamp tubes, material saving for circuit substrates, heat-dissipation enhancement, and easy replacement of lamp tubes, by the design of an assembled structure of a heat-dissipating ring, a transparent ring, and an LED emitter, which results in the LED lamp tube formed as a circular ring-shaped or other shaped annulus with heat-dissipation capability.

For achieving the above object, an LED lamp tube according to one embodiment of the present invention comprises: a heat-dissipating ring presented as an annulus having a ring base, an inner ring plate, and an outer ring plate; a transparent ring, an inner edge thereof being bonded to the inner ring plate of the heat-dissipating ring, and an outer edge thereof being bonded to the outer ring plate of the heat-dissipating ring; and an LED emitter, including at least two circuit substrates connected to each other to form a ring; at least one LED die bonded to each of the circuit substrates; at least one transformer; and a connection terminal, the LED emitter being further bonded between the heat-dissipating ring and the transparent ring.

For said heat-dissipating ring, the ring base is presented as a plane, as well as the inner ring plate and the outer ring plate are arc plates symmetrical to each other. Moreover, the heat-dissipating ring is made of metal. The cross section of said transparent ring is semicircular. Said heat-dissipating ring is provided on an inner surface of the ring base thereof with at least two positioning posts, each of said positioning posts being provided with a threaded hole. Said circuit substrates of the LED emitter are fixed on the positioning posts. A fixing element to be screwed into the threaded hole is penetratingly provided on the corresponding circuit substrate. Said LED emitter comprises three circuit substrates connected to one another to form a ring. Each of the circuit substrates is bonded with a transformer, respectively, and one of the circuit substrates is selected to be bonded at an inner edge thereof with said connection terminal. Additionally, said heat-dissipating ring, said transparent ring, and said circuit substrates of the LED emitter are formed as a circular ring-shaped or other shaped annulus.

Thereby, the effects of shape diversity of LED lamp tubes, material saving for circuit substrates, heat-dissipation enhancement for LEDs by means of the heat-dissipation ring, and easy replacement of lamp tubes may be achieved by an LED lamp tube of the present invention.

### BRIEF DESCRIPTION OF THE DRAWINGS

FIG. 1 is an exploded perspective view of one embodiment of the present invention;

FIG. 2 is a perspective view of the embodiment of the present invention after it is assembled and in use;

FIG. 3 is an assembled sectional view of the embodiment of the present invention;

FIG. 4 is an enlarged diagram of the embodiment of the present invention shown in FIG. 3; and

FIG. 5 is a structural diagram for circuit substrate cutting of the embodiment of the present invention.

### DESCRIPTION OF THE PREFERRED EMBODIMENTS

For the best understanding the objects, features, and effects of the present invention, the invention will be described in detail by reference to the following embodiment, taken in conjunction with accompanied drawings, as follows:

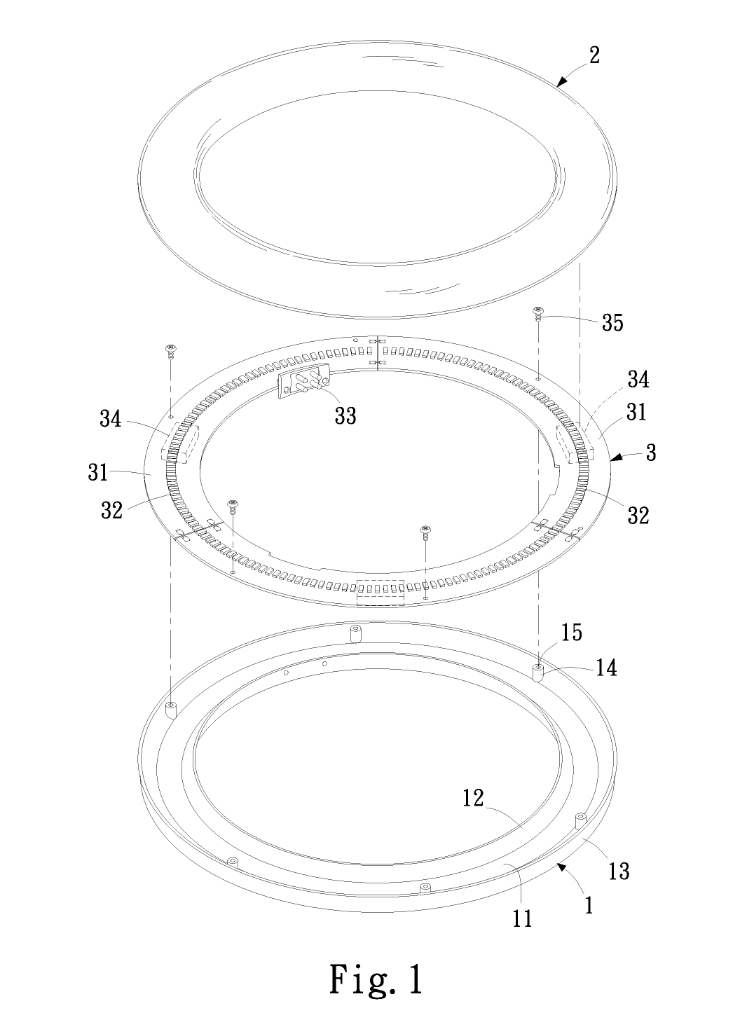

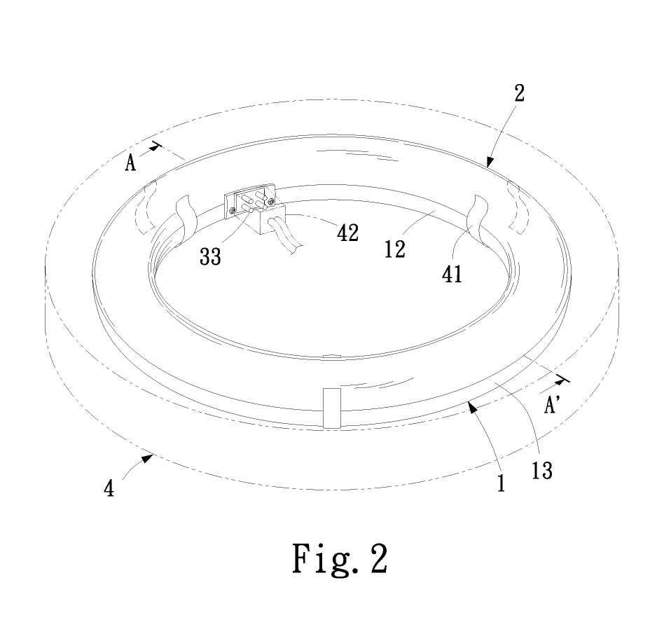

As shown in FIGS. 1 and 2, an LED lamp tube of the present invention, in one preferred embodiment, comprises: a heat-dissipating ring 1, a transparent ring 2, and an LED emitter 3, and is then installed in an LED lamp device 4.

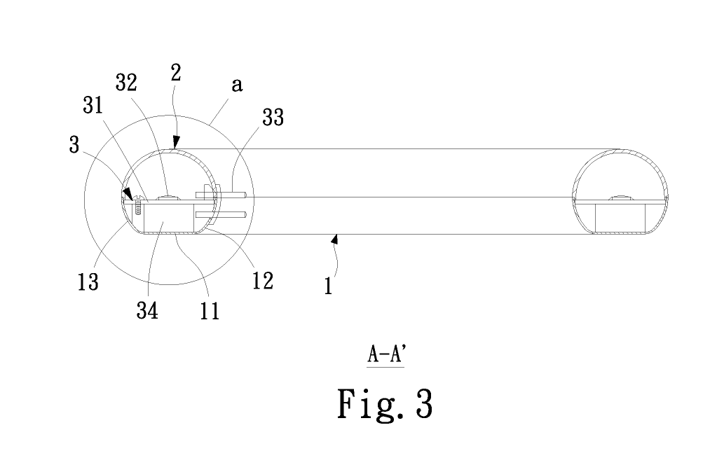

In this connection, the heat-dissipating ring 1, as shown in FIGS. 1 and 3, is an annulus having a ring base 11, an inner ring plate 12 bonded to an inner edge of the ring base 11, and an outer ring plate 13 bonded to an outer edge of the ring base 11. The ring base 11 may be presented as a plane, as well as the inner ring plate 12 and the outer ring plate 13 may be presented as arc plates or other shaped plates symmetrical to each other. Moreover, the whole heat-dissipating ring 1 is made of metal with better thermal conductivity.

The transparent ring 2, as shown in FIGS. 1 and 3, is an annulus of semicircular cross section. Furthermore, an inner edge of the transparent ring 2 is bonded to the inner ring plate 12 of the heat-dissipating ring 1, and an outer edge of the transparent ring 2 is bonded to the outer ring plate 13 of the heat-dissipating ring 1, so as to form an annular hollow tube.

The LED emitter 3, as shown in FIGS. 1 and 3, comprises at least two circuit substrates 31 connected to each other to form a ring, at least one LED die 32 (a plurality of LED dies 32 in the preferred embodiment shown in the figures) bonded to each of the circuit substrates 31, at least one transformer 34, and a connection terminal 33. Moreover, the LED emitter 3 is bonded between the heat-dissipating ring 1 and the transparent ring 2, in such a way that the LED die 32 is allowed to radiate toward the transparent ring 2. Thereby, the LED lamp tube of the present invention may be formed.

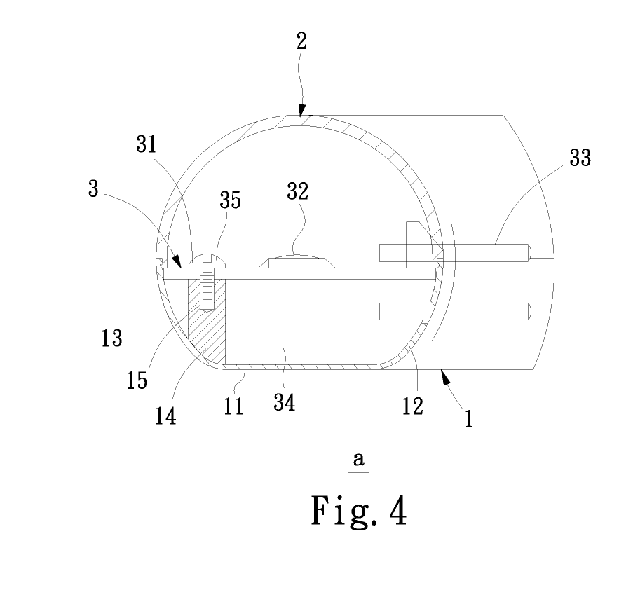

Referring to FIG. 1 again and FIG. 4, the preferred embodiment of the present invention comprises: at least two positioning posts 14 provided on an inner surface of the ring base 11 of the heat-dissipating ring 1, allowing the circuit substrates 31 of the LED emitter 3 to be fixed on the positioning posts 14; and a threaded hole 15 provided at the end of each of the positioning posts 14, as well as a fixing element 35 to be screwed into the threaded hole 15 being penetratingly provided on the corresponding circuit substrate 31, the threaded hole and the fixing element being used for fixing, in which the fixing element 35 may be a screw. Furthermore, the LED emitter 3 may be embodied to comprise three circuit substrates 31 connected to one another to form a ring. Each of the circuit substrates 31 is bonded with a transformer 34, respectively, and one of the circuit substrates 31 may be selected to be bonded at an inner edge thereof with the connection terminal 33, which is used for quickly connecting to the LED lamp device 4. Additionally, the heat-dissipating ring 1, the transparent ring 2, and the circuit substrates 31 of the LED emitter 3 may be formed as a circular ring-shaped or other shaped annulus.

When the LED lamp tube with this structure designed according to the present invention is applied as shown in FIG. 2, it may be installed in the circular or other shaped LED lamp device 4. The LED lamp tube of the present invention is fixed via a fastener 41 of the LED lamp device 4, and the connection terminal 33 of the LED emitter 3 is then pluggingly connected to an electrical connector 42 of the LED lamp device 4. Thereby, a lighting apparatus is formed.

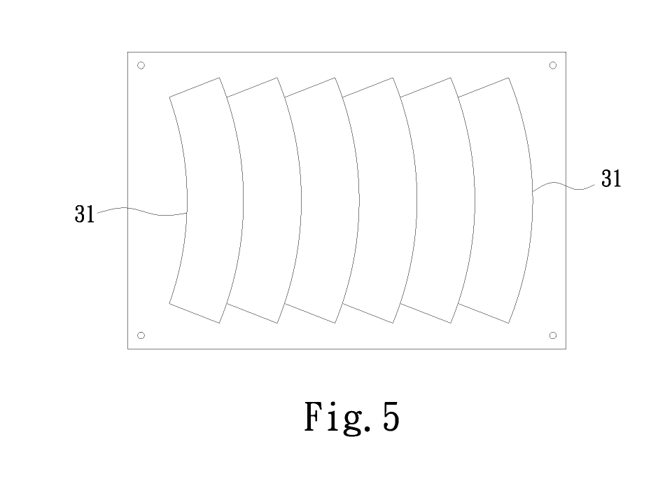

The LED emitter 3 of the present invention is provided with the at least two circuit substrates 31 connected to each other to form a ring. Therefore, as shown in FIG. 5, a raw material for circuit substrates may be cut, in a material-saving configuration, into the circuit substrates 31, and these circuit substrates may be then assembled as a circular ring-shaped or other shaped annulus. Thus, the heat-dissipating ring 1 and the transparent ring 2 may be also implemented as circular ring-shaped or other shaped annuli. As such, the effects of shape diversity of LED lamp tubes and material saving for circuit substrates may be achieved. In addition, the heat-dissipating ring 1 of the present invention is made of metal with better thermal conductivity, or a compound of pottery clay and plastics, and is thus not only used as a part of the structure of the lamp tube, but also allowed to enhance the heat-dissipation of the LED, whereby a rational and progressive design for heat-dissipating structure is truly provided. Moreover, the LED emitter 3 is provided with the connection terminal 33, capable of being pluggingly connected to the electrical connector 42 of the LED lamp device 4, in such a way that the LED emitter 3 may be replaced easily by a user himself when its service life is ended, and the effect of easy replacement of lamp tubes may be achieved thereby.

As described above, the present invention fully meets three essential requirements for patentability: novelty, advancement, and industrial applicability. For novelty and advancement, the effects of shape diversity of LED lamp tubes, material saving for circuit substrates, heat-dissipation enhancement, and easy replacement of lamp tubes may be achieved in the present invention, by the design of an assembled structure of the heat-dissipating ring, the transparent ring, and the LED emitter, which results in the LED lamp tube formed as the circular ring-shaped or other shaped annulus. For industrial applicability, products derived from the present invention should fully meet current market demands.

While the present invention has been disclosed with reference to one preferred embodiment in the foregoing description, those skilled in the art will appreciate that the embodiment is intended to be illustrative of the invention only and is not to be construed as limiting the scope of the invention. It should be noted that all equivalent modifications and alternatives with respect to the embodiment are included within the scope of the invention. Therefore, the invention intended to be protected is defined by the appended claims.

What is claimed is:

1. An LED lamp tube comprising:
a heat-dissipating ring, presented as an annulus having a ring base, an inner ring plate, and an outer ring plate;
a transparent ring, an inner edge thereof being bonded to said inner ring plate of said heat-dissipating ring, and an outer edge thereof being bonded to said outer ring plate of said heat-dissipating ring; and
an LED emitter, including at least two circuit substrates connected to each other to form a ring, at least one LED die bonded to each of said circuit substrates, at least one transformer, and a connection terminal, said LED emitter being further bonded between said heat-dissipating ring and said transparent ring.

2. The LED lamp tube according to claim 1, wherein said ring base of said heat-dissipating ring is presented as a plane, as well as said inner ring plate and said outer ring plate of said heat-dissipating ring are arc plates symmetrical to each other.

3. The LED lamp tube according to claim 1, wherein the material of said heat-dissipating ring is metal, or a compound of pottery clay and plastics.

4. The LED lamp tube according to claim 1, wherein the cross section of said transparent ring is semicircular.

5. The LED lamp tube according to claim 1, wherein said heat-dissipating ring is provided on an inner surface of said ring base thereof with at least two positioning posts, and said circuit substrates of said LED emitter are fixed on said positioning posts.

6. The LED lamp tube according to claim 5, wherein each of said positioning posts is provided with a threaded hole, and a fixing element to be screwed into said threaded hole is penetratingly provided on said corresponding circuit substrate.

7. The LED lamp tube according to claim 1, wherein said LED emitter comprises three circuit substrates connected to one another to form a ring, each of said circuit substrates being bonded with a transformer, respectively, and one of said circuit substrates being selected to be bonded at an inner edge thereof with said connection terminal.

8. The LED lamp tube according to claim 1, wherein said heat-dissipating ring, said transparent ring, and said circuit substrates of said LED emitter are formed in circular ring shape.
